(19) United States
(12) Patent Application Publication
(10) Pub. No.: US 2009/0057598 A1
(43) Pub. Date: Mar. 5, 2009

(54) Resilient Wedge Gate Valve

(75) Inventor: Kitti Anawatkochakorn, Bangkok (TH)

Correspondence Address: THE WEBB LAW FIRM, P.C., 700 KOPPERS BUILDING, 436 SEVENTH AVENUE, PITTSBURGH, PA, 15219, US

(73) Assignee: SIAM CAST IRON WORKS CO., LTD., Samutsakorn (TH)

(21) Appl. No.: 12/201,050

(22) Filed: Aug. 29, 2008

(30) Foreign Application Priority Data
Aug. 31, 2007 (TH) 0701004386

(51) Int. Cl. F16K 3/30

(52) U.S. Cl. 251/329

(57) ABSTRACT

A resilient wedge for a gate valve displaceable by a valve stem along a longitudinal axis extending through at least a portion of a valve body. The resilient wedge is displaceable between an open position and a closed position and includes a pair of wedge guides each having a channel portion for engaging respective body guides on an interior cavity of the valve body. A wedge body having a pair of slots is configured to receive at least a portion of the wedge guides.

### BACKGROUND OF THE INVENTION

1. Field of the Invention

The present invention relates to gate valves and, more particularly, to gate valves having a resilient wedge.

2. Description of Related Art

Gate valves are well known and typically control the flow of a fluid by moving a gate or wedge into a seated position to block the flow of the fluid through a flow passageway in the valve body. Certain gate valve designs utilize a resilient or flexible wedge in an effort to provide a better seal compared to solid wedge gate valve designs, such that distortions of the seating face caused by changes in temperature or pressure are accommodated by the resilient wedge to prevent binding of the valve. In certain gate valve designs, the valve body includes a pair of protruding guides or ribs to guide the wedge and keep it in alignment as the wedge slides up and down from an open position to a closed position. The guides or ribs also prevent the wedge from being displaced in a downstream direction during movement from an open position to a closed position.

After extended use of the gate valve, however, the guides or ribs often become worn and the flexible portion of the wedge may become damaged causing both the guides and the wedge to become corroded. The corroded guides and wedge often cause the torque required to open and close the valve to become higher and may also lead to failure of the valve.

### SUMMARY OF THE INVENTION

In one embodiment of the present invention, a resilient wedge for a gate valve is provided. The resilient wedge is displaceable by a valve stem along a longitudinal axis extending through at least a portion of a valve body. The resilient wedge is displaceable between an open position and a closed position and includes a pair of wedge guides each having a channel portion for engaging respective body guides on an interior cavity of the valve body. A wedge body having a pair of slots is configured to receive at least a portion of the wedge guides.

In a further embodiment of the present invention, a gate valve is provided. The gate valve includes a valve body defining a fluid flow passage therethrough. The valve body has an interior cavity and a pair of body guides within the interior cavity. A bonnet having an opening is secured to the valve body. A resilient wedge is disposed within at least a portion of the interior cavity and is displaceable between an open position and a closed position. The resilient wedge includes a pair of wedge guides each having a channel portion for engaging the body guides of the valve body, and a wedge body having a pair of slots configured to receive at least a portion of the wedge guides. A valve stem having a first end and a second end extends through the opening of the bonnet defining a longitudinal axis. The first end of the valve stem engages the resilient wedge, and actuation of the second end of the valve stem displaces the resilient wedge between the open position and the closed position.

### BRIEF DESCRIPTION OF THE DRAWINGS

FIG. 1 is a cut-away perspective view of a gate valve according to one embodiment of the present invention;

FIG. 2 is a front partial cross-sectional view of the resilient wedge shown in FIG. 1;

FIG. 3 is a side partial cross-sectional view of the resilient wedge shown in FIG. 1;

FIG. 4 is a bottom view of the resilient wedge shown in FIG. 1;

FIG. 5 is a side partial cross-sectional view of the wedge guide shown in FIG. 1;

FIG. 6 is a front partial cross-sectional view of the wedge guide shown in FIG. 1;

FIG. 7 is a cross-sectional view of the wedge guide taken along the A-A in FIG. 5.

### DESCRIPTION OF THE PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific valves illustrated in the accompanying drawing figures and described herein are simply exemplary and should not be considered as limiting.

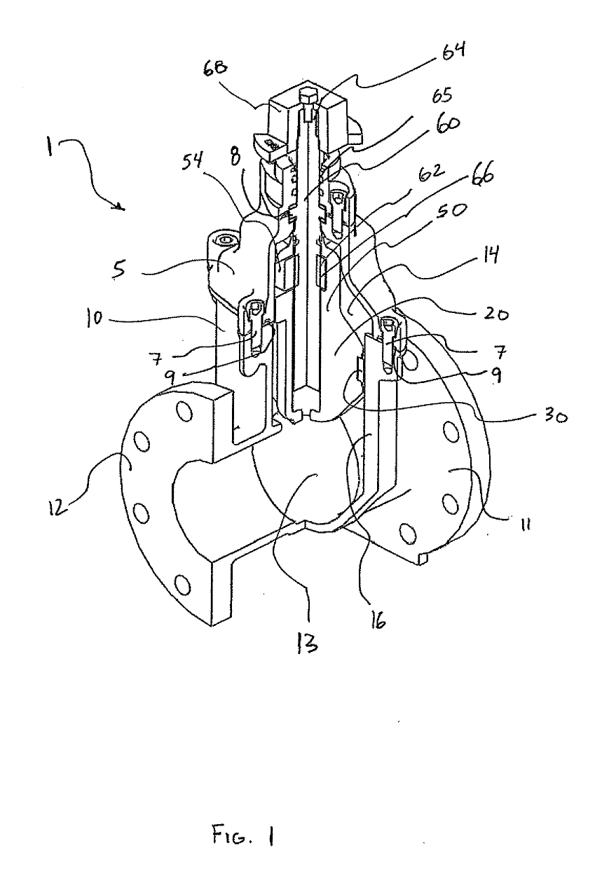

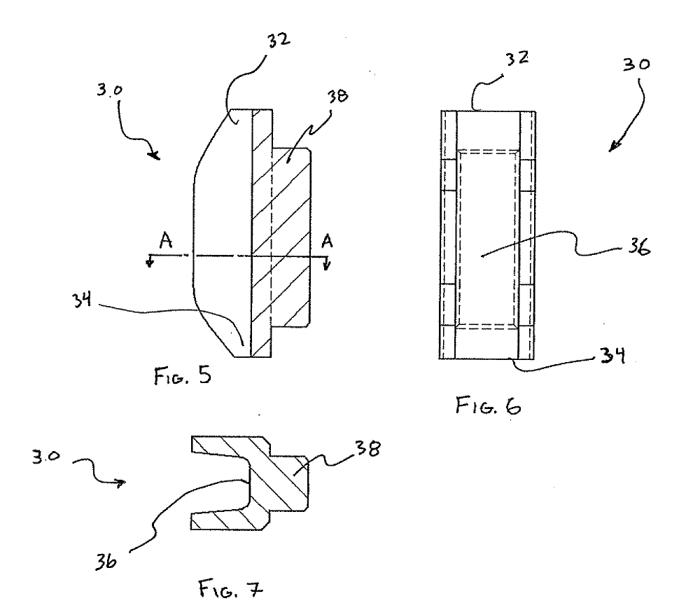

In one embodiment, shown in FIGS. 1-7, a gate valve 1 is disclosed having a bonnet 5 secured to the valve body 10 via bolts 7 with a gasket 9 between the bonnet 5 and the valve body 10. The bonnet 5 has an opening 8 positioned on the top of the bonnet 5 for receiving a valve stem 60. The valve body 10 has a fluid flow passageway 13, an interior cavity 14, and a pair of body guides 16 within the interior cavity 14. As shown in FIG. 1, the body guides 16 may be a vertically oriented rib projecting from the valve body 10 into the interior cavity 14. Further, the valve body may have an inlet flange 11 and an outlet flange 12 for connecting with respective flanges of a pipe (not shown).

A resilient wedge 20 having a wedge body 50 and a pair of wedge guides 30 is disposed within the bonnet 5 and the interior cavity 14 of the valve body 10. The resilient wedge 20 is displaceable between an open position and a closed position, such that the fluid flow passageway 13 is open when the resilient wedge 20 is in the open position and the fluid flow passageway 13 is closed when the resilient wedge 20 is in the closed position. The pair of wedge guides 30 have a channel portion 36 that may extend from a first end 32 to a second end 34 of the wedge guides 30. The channel portion 36 receives the body guides 16 of the valve body 10 to support the resilient wedge 20 when it is moved from the open position to the closed position and vice versa. The sliding engagement of the channel portion 36 with the body guides 16 also prevents displacement of the resilient wedge 20 due to the pressure and flow of water through the fluid flow passageway 13. Further, the wedge body 50 includes slots 52 for receiving at least a portion of the wedge guides 30 and, as shown more clearly in FIG. 2, a cavity 54 for receiving a stem nut 66 as discussed below.

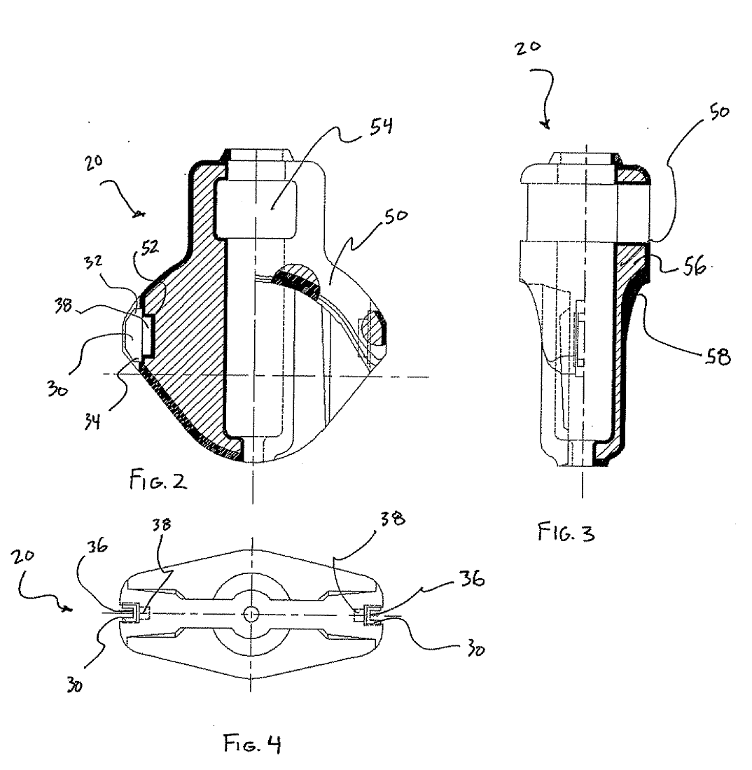

In certain embodiments, as shown in more clearly in FIG. 7, the wedge guides 30 may have a substantially Y-shaped cross-section defining a boss 38. The boss 38 may be received by the slots 52 in the wedge body 50 to firmly hold the wedge guide in the wedge 50. For example, the boss 38 may have an interference fit with the slot 52 in the wedge body 50. As more clearly shown in FIG. 3, the resilient wedge 20 may be made of a metal portion 56 encapsulated with a rubber portion 58. In a particular embodiment, the metal portion 56 is cast iron or ductile iron encapsulated by Nitrile butadiene rubber (NBR) or Ethylene propylene diene monomer rubber (EPDM). The resilient wedge 20 may be encapsulated by rubber 58 via a molding process to bond the rubber 58 to the outside of the wedge body 50 such that the metal portion 56 of the wedge body 50 is not visible. The wedge guides 30 may be made of plastic, such as Polyoxymethylene (POM).

The valve stem 60 has a first end 62 and a second end 64 and extends through the opening 8 in the bonnet 5 to define a longitudinal axis. The first end 62 of the valve stem 60 engages the resilient wedge such that actuation of the second end 64 of the valve stem 60 displaces the resilient wedge 20 between the open position and the closed position. As shown in FIG. 1, the first end 62 of the valve stem 60 may engage the resilient wedge 20 via a stem nut 66 positioned on the first end 62 of the valve stem 60 within a cavity 54 of the wedge body 50. Further, the second end 64 of the valve stem 60 may be actuated by rotating an operating nut 68 positioned on the second end 64 of the stem 60. When the valve stem 60 is rotated in a counter-clockwise direction via the operating nut 68, the stem nut 66 will move based on the orientation of the threads on the valve stem 60. Thus, if the valve stem 60 has a left-hand thread orientation, rotating the operating nut 68 in a clockwise direction will move the stem nut 66 downward along the longitudinal axis.

As discussed above, the wedge guides 30 of the resilient wedge 20 may be made of plastic, such that the friction between the guides 30 and the body guides 16 is reduced allowing smooth movement of the resilient wedge 20 and lowering the amount torque required to operate the valve 1 compared to prior art gate valves. The wedge guides 30 also protect the body guides 16 to prevent the peeling or scratching of any coatings applied to the body guides 16 and protect the rubber 58 on the wedge body 50 to extend the life of the gate valve 1. Furthermore, the wedge guides 30 may be easily replaced without replacing the entire resilient wedge 20 saving labor, time, and resources. Encapsulating the wedge body 50 with rubber protects the metal portion 56 from liquid and air and helps to extend the lifetime of the valve 1. The rubber portion 58 of the wedge body 50 also ensures the boss 38 of the wedge guide 30 is firmly secured in the slots 52 during operation of the valve 1.

While certain embodiments of the gate valve and wedge guide were described in the foregoing detailed description, those skilled in the art may make modifications and alterations to these embodiments without departing from the scope and spirit of the invention. Accordingly, the foregoing description is intended to be illustrative rather than restrictive.

The invention claimed is:

1. A resilient wedge for a gate valve, the resilient wedge being displaceable by a valve stem along a longitudinal axis extending through at least a portion of a valve body, the resilient wedge being displaceable between an open position and a closed position, the resilient wedge comprising:
a pair of wedge guides each having a channel portion for engaging respective body guides on an interior cavity of the valve body; and
a wedge body having a pair of slots configured to receive at least a portion of wedge guides.

2. The resilient wedge of claim 1, wherein the wedge body further comprises a cavity for receiving at least a portion of a stem nut positioned on an end of the valve stem.

3. The resilient wedge of claim 1, wherein the wedge guides have a boss configured to removably engage the slot guides of the wedge body.

4. The resilient wedge of claim 3, wherein the wedge guides have a substantially Y-shaped cross-section.

5. The resilient wedge of claim 4, wherein the channel portion of the wedge guides extends from a first end to a second end of each wedge guide.

6. The resilient wedge of claim 1, wherein the wedge body is made of iron encapsulated with rubber.

7. The resilient wedge of claim 6, wherein the iron is one of cast iron and ductile iron.

8. The resilient wedge of claim 6, wherein the rubber is one of Nitrile butadiene rubber (NBR) and Ethylene propylene diene monomer rubber (EPDM).

9. The resilient wedge of claim 6, wherein the rubber is bonded to the iron.

10. The resilient wedge of claim 1, wherein the wedge guides are made of plastic.

11. A gate valve comprising:
a valve body defining a fluid flow passage therethrough, the valve body having an interior cavity and a pair of body guides within the interior cavity;
a bonnet having an opening and secured to the valve body;
a resilient wedge disposed within at least a portion of the interior cavity and displaceable between an open position and a closed position, the resilient wedge comprising:
a pair of wedge guides each having a channel portion for engaging the body guides of the valve body; and
a wedge body having a pair of slots configured to receive at least a portion of the wedge guides; and
a valve stem having a first end and a second end, the valve stem extending through the opening of the bonnet defining a longitudinal axis, wherein the first end of the valve stem engages the resilient wedge, and actuation of the second end of the valve stem displaces the resilient wedge between the open position and the closed position.

12. The resilient wedge of claim 1, wherein the first end of the valve stem engages the resilient wedge via a stem nut disposed within a cavity of the wedge body.

13. The resilient wedge of claim 11, wherein the wedge guides have a boss configured to removably engage the slot guides of the wedge body.

14. The resilient wedge of claim 13, wherein the wedge guides have a substantially Y-shaped cross-section.

15. The resilient wedge of claim 14, wherein the channel portion of the wedge guides extends from a first end to a second end of the wedge guide.

16. The resilient wedge of claim 11, wherein the wedge body is made of iron encapsulated with rubber.

17. The resilient wedge of claim 16, wherein the iron is one of cast iron and ductile iron.

18. The resilient wedge of claim 16, wherein the rubber is one of Nitrile butadiene rubber (NBR) and Ethylene propylene diene monomer rubber (EPDM).

19. The resilient wedge of claim 16, wherein the rubber is bonded to the iron.

20. The resilient wedge of claim 11, wherein the wedge guides are made of plastic.
